(19) United States
(12) Patent Application Publication
(10) Pub. No.: US 2008/0121799 A1
(43) Pub. Date: May 29, 2008

(54) SAMPLE ANALYZING APPARATUS

(76) Inventors: Chohei Kanno, Tokyo (JP); Hirotami Koike, Tokyo (JP); Toru Tojo, Tokyo (JP)

Correspondence Address: DICKSTEIN SHAPIRO LLP, 1825 EYE STREET NW, Washington, DC, 20006-5403, US

(21) Appl. No.: 11/932,083

(22) Filed: Oct. 31, 2007

(30) Foreign Application Priority Data
Nov. 1, 2006 (JP) 2006-297764

(51) Int. Cl. G21K 5/00

(52) U.S. Cl. 250/306

(57) ABSTRACT

A sample analyzing apparatus includes: an irradiation system which irradiates a charged particle onto a sample having a concave portion partially on a surface thereof; a light condensing reflecting mirror which condenses luminescence obtained from the surface based on the irradiation of the charged particle; a light detector which detects the luminescence guided to the light condensing reflecting mirror; a charged particle detector which detects the charged particle reflected from the surface of the sample as a reflection charged particle; and a signal processor which controls the irradiation system to irradiate the charged particle intermittently, which obtains a shape of the sample on the basis of a detection signal outputted from the charged particle detector, and which identifies a material of the sample on the basis of an attenuation characteristic of a detection signal outputted from the light detector in a period from a time point in which the intermittent irradiation of the charged particle by the irradiation system is ended to a time point in which the intermittent irradiation of the charged particle by the irradiation system is started.

### PRIORITY CLAIM

The present application is based on and claims priority from Japanese Patent Application No. 2006-297764, filed on Nov. 1, 2006, the disclosure of which is hereby incorporated by reference in its entirety.

### BACKGROUND

The present invention relates to a sample analyzing apparatus preferable for analyzing a sample having a large thickness.

Conventionally, there has been known a sample analyzing apparatus which irradiates an electron beam as a charged particle onto a surface of a sample, including a wafer as a semiconductive material, to detect cathodoluminescence generated thereon, and which performs analysis of the sample based on the detected cathodoluminescence.

For example, Japanese Patent Application Publication No. H10-38805 discloses a device which detects cathodoluminescence emitted from a back face of a sample onto which an electron beam is irradiated. The device disclosed in JP-H10-38805A detects a secondary electron as well to display a luminescence image of a semiconductor crystal correspondingly to a shape or the like of the sample, so as to determine presence of a residual film and detect its position. The device also recognizes a shape or the like of a contact hole.

FIG. 1 is a partial cross-sectional view illustrating one example of a structure of a sample having a large film thickness. The sample including a wafer illustrated in FIG. 1 has a semiconductor layer film 2 having a thickness of few angstrom to few micrometers formed on a surface of an insulating substrate 1, such as a silicon having a thickness of approximately 800 micrometers. A surface of the semiconductor layer film 2 is formed with a resist film 3, and a contact hole 4 is formed on the resist film 3. Here, the sample may be subjected to inspection as to whether or not the contact hole 4 is formed to meet a corresponding standard.

However, since the conventional sample analyzing apparatus including the device disclosed in JP-H10-38005A employs a structure in which the cathodoluminescence is detected from the back face of the sample, there is a problem in that the inspection as to whether or not the contact hole is formed to meet the corresponding standard cannot be done for the sample or the wafer having a structure, illustrated in FIG. 1 for example, in which the film thickness is large.

Further disadvantage in the conventional sample analyzing apparatus including the device disclosed in JP-H10-38805A is that identification of a material of the sample is difficult.

### SUMMARY

At least one objective of the present invention is to provide a sample analyzing apparatus which is preferable for analyzing a sample having a large thickness, and which is also possible to perform identification of a material of the sample.

To achieve these and other advantages and in accordance with the purpose of the invention, as embodied and broadly described herein, the invention provides a sample analyzing apparatus, comprising: an irradiation system which intermittently irradiates a charged particle onto a sample having a concave portion partially on a surface thereof; a light condensing reflecting mirror which condenses luminescence obtained from a side of the surface based on the irradiation of the charged particle; a light detector which detects the luminescence guided to the light condensing reflecting mirror and which outputs a detection signal based on the detected luminescence; a charged particle detector which detects the charged particle reflected from the surface of the sample as a reflection charged particle and which outputs a detection signal based on the detected reflection charged particle; and a signal processor which controls the irradiation system to irradiate the charged particle intermittently, which obtains a shape of the sample on the basis of the detection signal outputted from the charged particle detector, and which identifies a material of the sample on the basis of an attenuation characteristic of the detection signal outputted from the light detector in a period from a time point in which the intermittent irradiation of the charged particle by the irradiation system is ended to a time point in which the intermittent irradiation of the charged particle by the irradiation system is started.

In accordance with an embodiment of invention, the sample includes a semiconductor having a resist on the surface, and the concave portion includes a contact hole.

Advantageously, the sample analyzing apparatus further comprises a memory which stores therein a previously set predetermined value, wherein the signal processor identifies the material of the sample on the basis of an attenuation time, as the attenuation characteristic, that a value of the detection signal, obtained from the light detector in the time point in which the intermittent irradiation of the charged particle by the irradiation system is ended, is reduced to the predetermined value.

Advantageously, the sample analyzing apparatus further comprises a memory which stores therein a previously set predetermined value, wherein the attenuation characteristic includes an attenuation time that a value of the detection signal, obtained from the light detector in the time point in which the intermittent irradiation of the charged particle by the irradiation system is ended, is reduced to the predetermined value, and wherein the signal processor determines that the contact hole does not meet a standard when the attenuation time is less than the predetermined value, and determines that the contact hole meets the standard when the attenuation time is more than the predetermined value.

Advantageously, the sample analyzing apparatus further comprises a memory which stores therein a previously set predetermined value, wherein the attenuation characteristic includes an attenuation time that a value of the detection signal, obtained from the light detector in the time point in which the intermittent irradiation of the charged particle by the irradiation system is ended, is reduced to the predetermined value, and wherein the signal processor determines that the contact hole does not meet a standard when the attenuation time is more than the predetermined value, and determines that the contact hole meets the standard when the attenuation time is less than the predetermined value.

Advantageously, the sample analyzing apparatus further comprises a spectrometer which resolves the luminescence into each wavelength to be guided to the light detector, wherein the light detector outputs the detection signal in which the luminescence is resolved by the spectrometer into each of the wavelengths, and wherein the signal processor identifies the material of the sample on the basis of the attenuation time of the detection signal which is outputted from the light detector and in which the luminescence is resolved into each of the wavelengths.

Advantageously, the sample analyzing apparatus further comprises a spectrum prism which resolves the luminescence into each wavelength to be guided to the light detector, wherein the light detector outputs the detection signal in which the luminescence is resolved by the spectrum prism into each of the wavelengths, and wherein the signal processor identifies the material of the sample on the basis of the attenuation time of the detection signal which is outputted from the light detector and in which the luminescence is resolved into each of the wavelengths.

Advantageously, the signal processor controls the irradiation system to vary acceleration voltage of the charged particle, and identifies the material of the sample on the basis of the acceleration voltage, in addition to the attenuation time.

Advantageously, the signal processor measures peak values of the luminescence for each of the wavelengths, compares the attenuation time and the peak values obtained by the actual measurement with attenuation time and peaks values as known values for each material stored in the memory, and identifies the material of the sample on the basis of the comparison of the attenuation time and the peak values obtained by the actual measurement and the attenuation time and the peaks values of each material stored in the memory.

Advantageously, the signal processor measures peak values of the luminescence for each of the wavelengths, compares the attenuation time and the peak values obtained by the actual measurement with attenuation time and peaks values as known values for each material stored in the memory, and identifies the material of the sample on the basis of the comparison of the attenuation time and the peak values obtained by the actual measurement and the attenuation time and the peaks values of each material stored in the memory.

Advantageously, the irradiation system includes an optical element which varies a focusing position of the charged particle when the charged particle is irradiated onto the sample, and wherein the signal processor drives the optical element to adjust the focusing position of the charged particle on the basis of the detection signal outputted from the light detector.

Advantageously, the sample analyzing apparatus further comprises a memory which stores therein a previously set predetermined value, wherein the signal processor determines that the irradiation of the charged particle onto the surface of the sample is performed when an output level of the detection signal from the charged particle detector is equal to or more than the predetermined value, and determines that the irradiation of the charged particle to the concave portion is performed when the output level of the detection signal from the charged particle detector is less than the predetermined value.

Advantageously, the signal processor includes a constant driving mode for controlling the irradiation system to irradiate the charged particle onto the surface of the sample constantly, and an intermittent driving mode for controlling the irradiation system to irradiate the charged particle on the surface of the sample intermittently.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the specification, serve to explain the principles of the invention.

FIG. 1 is a partial cross-sectional view illustrating one example of a structure of a sample.

FIG. 2 illustrates a structure of a main part of a sample analyzing apparatus according to an embodiment of the present invention.

FIG. 3A is an expanded partial cross-sectional view illustrating one example of a sample according to the embodiment of the present invention, in which various contact holes formed on the sample are illustrated.

FIG. 3B schematically illustrates a fluorescent image obtained in a state in which the contact hole has penetrated a resist film to reach a second semiconductor layer film but has not reached a first semiconductor layer film of the contact hole illustrated in FIG. 3A.

FIG. 3C schematically illustrates a fluorescent image obtained in a state in which the contact hole has penetrated the resist film and the second semiconductor layer film, and has just reached a surface of the first semiconductor layer film of the contact hole illustrated in FIG. 3A.

FIG. 3D schematically illustrates a fluorescent image obtained in a state in which the contact hole has penetrated the resist film and the second semiconductor layer film and has reached the surface of the first semiconductor layer film, but a residue is present inside of the contact hole illustrated in FIG. 3A.

FIG. 3E schematically illustrates a fluorescent image obtained in a state in which the contact hole has penetrated the resist film and the second semiconductor layer film, and has further reached an inner part or a back part of the first semiconductor layer film from the surface of the first semiconductor layer film of the contact hole illustrated in FIG. 3A.

FIG. 4 illustrates one example of an image obtained by a reflection secondary electron of a charged particle.

FIG. 5 is a schematic diagram illustrating one example of intermittent irradiation of an electron beam, wherein a part (a) represents a period of the intermittent irradiation of the electron beam, and a part (b) represents an attenuation characteristic of luminescence generated by the intermittent irradiation of the electron beam.

FIG. 6 is a graph illustrating a relationship between wavelengths and signal intensity of the luminescence.

FIG. 7 schematically illustrates a state in which the electron beam is in focus on a surface of the sample.

FIG. 8 schematically illustrates a state in which the electron beam is in focus on a bottom part of the contact hole of the sample.

FIG. 9 schematically illustrates a fluorescent image obtained by the electron beam focused on the bottom part of the contact hole.

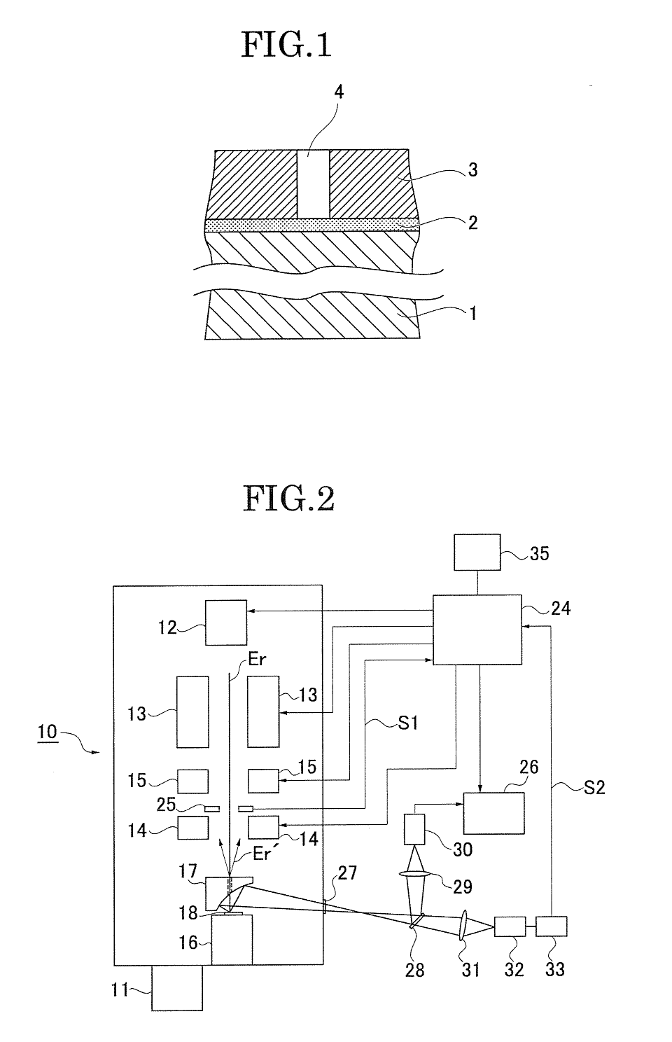

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts. The scope of the present invention, however, is not limited to these embodiments. Within the scope of the present invention, any structure and material described below can be appropriately modified.

FIG. 2 illustrates a structure of a main part of a sample analyzing apparatus according to an embodiment of the present invention. Referring to FIG. 2, a vacuum container 10 is illustrated. The vacuum container 10 is connected with an exhaust system 11 to be high in vacuum therein. The exhaust system 11 may be a turbo pump, an ion pump, or other suitable devices. The vacuum container 10 is provided therein with an electron gun 12, an electron gun optical system 13, an electron lens 14, an electron beam deflector 15, an XYZ stage 16, and a rotative ellipse reflecting mirror 17 as a light condensing reflecting mirror according to the present embodiment, for example.

In the present embodiment, the electron gun 12, the electron gun optical system 13, the electron lens 14, and the electron beam deflector 15 functions as an irradiation system, which irradiates an electron beam Er, as a charged particle, toward a sample, which will be described later in detail. An acceleration voltage of the electron gun 12 is suitably varied by a later-described signal processor.

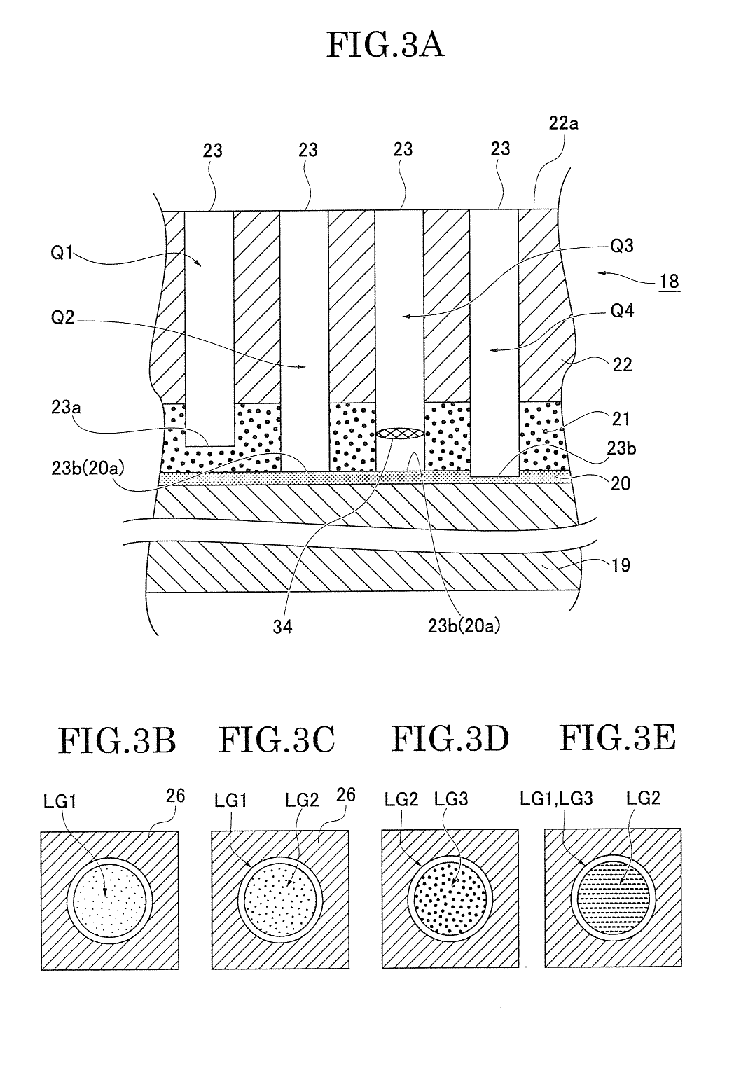

A wafer 18 as a sample in the present embodiment illustrated in FIG. 3A is set on the XYZ stage 16. Referring to FIG. 3A, which illustrates one example of the wafer 18 as the sample according to the embodiment, the wafer 18, for example, includes a first semiconductor layer film 20 formed on a surface of an insulating substrate 19, a second semiconductor layer film 21 formed on a surface on the first semiconductor layer film 20, and a resist film 22 formed on a surface of the second semiconductor layer film 21. The wafer 18 is further formed with contact holes 23, as concave portions, each extending from the resist film 22 to the first semiconductor layer film 20. The first semiconductor layer film 20 may have a thickness of few angstrom to few micrometers, and the insulating substrate 19 may be a silicon and may have a thickness of approximately 800 micrometers, although they are not limited thereto.

Driving modes of the electron gun 12 have a charged particle detection mode (or a constant driving mode, a secondary electron detection mode) and a luminescence detection mode (or an intermittent driving mode), and the electron gun 12 is driven and controlled by the signal processor 24. The electron gun 12 is, firstly, constantly driven by the signal processor 24, and thereby the electron beam Er is emitted toward the wafer 18. The emitted electron beam Er is focused by the electron gun optical system 13 and the electron lens 14 to be irradiated on the wafer 18 in a spot-like configuration. A position on the wafer 18 at which the electron beam Er is irradiated is changed by the electron beam deflector 15, and the wafer 18 is scanned two-dimensionally by the electron beam Er.

When the wafer 18 is irradiated by the electron beam Er, the wafer 18 radiates a reflection secondary electron Er′ from a portion in which the resist film 22 is formed. The irradiated reflection secondary electron Er′ is captured or detected by a charged particle detector 25. When the charged particle detector 25 detects the reflection secondary electron Er′, the charged particle detector 25 outputs a detection signal S1, which is inputted into the signal processor 24.

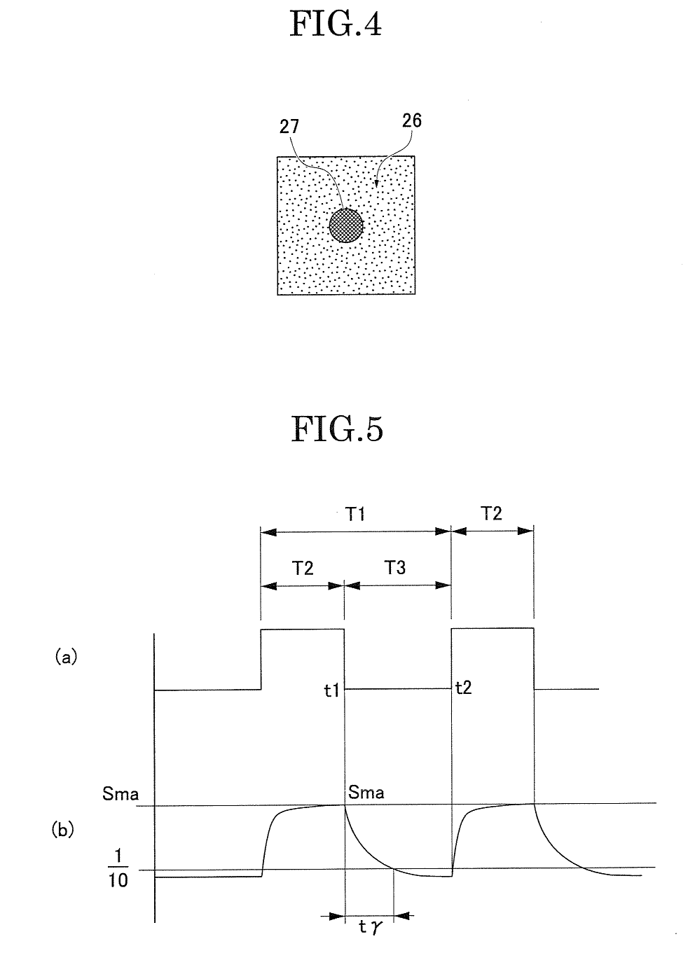

The signal processor 24 analyzes a shape of the surface of the wafer 18 on the basis of an output of the detection signal S1, and displays a result of the analysis on a screen of a display 26. FIG. 4 illustrates one example of an image obtained by the reflection secondary electron Er′. Referring to FIG. 4, since an amount of the reflection secondary electron Er′ becomes small in a portion on the wafer 18 on which the contact hole 26 is present, an image corresponding to the contact hole 23 is displayed dark on the screen of the display 26, as denoted by a reference sign 27.

The signal processor 24 two-dimensionally calculates a position in which the amount of the reflection secondary electron Er′ is small, and identifies a position at which the contact hole 23 is present. Then, the electron gun 12 is, secondly, intermittently driven by the signal processor 24, and thereby, the electron beam Er is emitted toward the wafer 18 during a period T1 for a predetermined time T2 illustrated in a part (a) of FIG. 5.

The resist film 22 does not have a property which generates fluorescence, so that the fluorescence or the luminescence is not generated by the resist film 22. On the other hand, the first semiconductor layer film 20 and the second semiconductor layer film 21 include a material having a property of generating the fluorescence. Thus, the first semiconductor layer film 20 and the second semiconductor layer film 21 generate the fluorescence when the electron beam Er contacts thereto.

The luminescence generated on the basis of the irradiation of the electron beam Er is condensed and reflected by the rotative ellipse reflecting mirror 17 provided on a side of the surface of the sample, and is guided to a half mirror 28 through an optical window 27 provided on the vacuum container 10.

The half mirror 28 transmits approximately half the amount of the luminescence therethrough, and reflects the remaining approximately half the amount of the luminescence. The luminescence reflected by the half mirror 28 is guided to a lens 29, and the reflected luminescence guided to the lens 29 is thereby imaged on a camera 30. An image obtained by the camera 30 is displayed on the display 26.

The luminescence transmitted through the half mirror 28 is guided to a spectrometer 32 or a spectrum prism 32 through a lens 31 to be resolved into luminescence for each wavelength. The luminescence resolved into each of the wavelengths is guided to a light detector 33, and intensity of the luminescence for each of the wavelengths is detected by the light detector 33.

Then, the light detector 33, based on the detection of the intensity of the luminescence, outputs a detection signal S2 to the signal processor 24. It is to be noted that an attenuation characteristic of the detection signal S2 differs depending on a substance of the fluorescent material included in the semiconductive material.

Referring to FIG. 5, when the electron beam Er is intermittently irradiated toward the sample as represented by the part (a) of FIG. 5, the detection signal S2 outputted from the light detector 33 attenuates in a period T3 from a time point t1 in which the intermittent irradiation of the electron beam Er is ended to a time point t2 in which the intermittent irradiation of the electron beam Er is started, as represented by a part (b) of FIG. 5.

In the present embodiment, the signal processor 24 measures an attenuation time tr that a peak value Sma of the detection signal S2, outputted from the light detector 33 in the time point t1 of the electron beam Er, is reduced to a value (or a predetermined value) one tenth for example of the peak value Sma, as the attenuation characteristic of the detection signal S2. The signal processor 24 then stores the measured attenuation time tr into a memory 35 as a storing device.

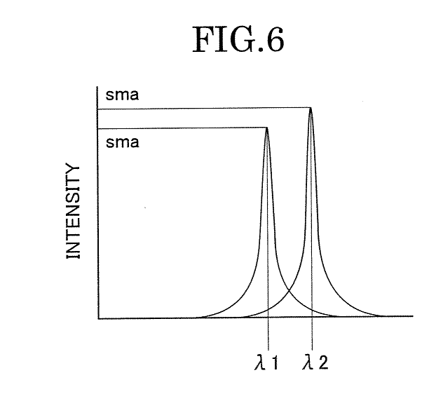

FIG. 6 is a graph illustrating a relationship between the wavelengths and the signal intensity of the luminescence. Referring to FIG. 6, the image processor 24 also measures the peak value Sma of the luminescence for respective wavelengths λ1 and λ2, compares the measured peak values Sma of the luminescence of the respective wavelengths with peak values previously stored in the memory 35, and stores the maximum peak values Sma into the memory 35.

Table 1 represents a relationship among the attenuation time tr for each of the florescent materials, a peak wavelength of the luminescence, and the acceleration voltage applied to the electron gun 12.

TABLE 1

| | Acceleration | Attenuation time | Peak wavelength |
|---|---|---|---|
| Fluorescent material | voltage (Kv) | to be 1/10 (ms) | (nm) |
| Zn₂SiO₄:Mn | 1.3 | 25.000 | 525 |
| ZnS:Cu | 2.2 | 20.0-50.0 | 530 |
| ZnO | 5.5 | 0.002 | 520 |

It can be seen from Table 1 that, for example, there is a little difference in terms of the maximum peak value among the fluorescent material of Zn₂SiO₄:Mn, the fluorescent material of ZnS:Cu, and the fluorescent material of ZnO. However, it can be also seen from Table 1 that there is a significant difference in the attenuation time tr as the attenuation characteristic among them.

Therefore, by measuring, with the signal processor 24, the attenuation time tr that the value of the detection signal S2 obtained by the light detector 33 is reduced to the predetermined value, i.e., from the peak value Sma to one tenth of the peak value Sma for example, the signal processor 24 is possible to identify the material of the sample. In the present embodiment, the predetermined value is set at one tenth of the peak value Sma, although it is not limited thereto.

More specifically, in the present embodiment, the attenuation time tr and the peak wavelengths λ1 and λ2 for each of the fluorescent materials are previously stored in the memory 35 as known values. Then, the attenuation time tr and the peak values λ1 and λ2 which are obtained by the actual measurement are compared with the known values for each of the fluorescent materials stored in the memory 35, to perform the identification of the material of the sample.

The present embodiment identifies the material of the sample based on the attenuation time t. In one embodiment of the invention, the identification of the material of the sample is performed by an attenuation characteristic including a shape of attenuation.

In addition, there is an acceleration voltage by which the luminescence is easily generated, depending on the fluorescent material. Therefore, the identification of the sample may be performed by taking the acceleration voltage into account as well.

The sample analyzing apparatus according to the present embodiment is also used for inspection of the wafer 18 having such a structure illustrated in FIG. 3A for example.

FIG. 3A illustrates a state Q1 of the contact hole 23 in which the contact hole 23 formed on the wafer 18 has penetrated the resist film 22 to reach the second semiconductor layer film 21 but has not reached the first semiconductor layer film 20, and a state Q2 in which the contact hole 23 has penetrated the resist film 22 and the second semiconductor layer film 21, and has just reached a surface 20a of the first semiconductor layer film 20. FIG. 3A also illustrates a state Q3 in which the contact hole 23 has penetrated the resist film 22 and the second semiconductor layer film 21 and has reached the surface 20a of the first semiconductor layer film 20, but a residue 34 is present inside of the contact hole 23, and a state Q4 in which the contact hole 23 has penetrated the resist film 22 and the second semiconductor layer film 21, and has further reached an inner part or a back part of the first semiconductor layer film 20 from the surface 20a of the first semiconductor layer film 20.

In a case of the wafer 18 having the structured illustrated in FIG. 3A, fluorescent images illustrated in FIGS. 3B to 3E according to the luminescence are obtained.

For example, in a case of the contact hole 23 illustrated by Q1 in FIG. 3A, a fluorescent image LG1 according to the luminescence from the second semiconductor layer film 21 which is present in a bottom part 23a of the contact hole 23 is obtained and displayed on the screen of the display 26, as illustrated in FIG. 3B. As illustrated in FIG. 3B, a central part of the fluorescent image LG1 is slightly dark and a circumferential contour part is brighter than the central part, since the luminescence from a circumferential wall of the contact hole 23 is present.

In a case of the contact hole 23 illustrated by Q2, as illustrated in FIG. 3C, a fluorescent image LG2 according to the luminescence from the first semiconductor layer film 20 which is present in a bottom part 23b, or the surface 20a of the semiconductor layer film 20, of the contact hole 23, and the fluorescent image LG1 according to the luminescence from the second semiconductor layer film 21 structuring the wall of the contact hole 23, are obtained and displayed on the screen of the display 26.

Since the fluorescent materials included in the first semiconductor layer film 20 and the second semiconductor layer film 21 are different, the wavelengths of the luminescence also differ. In the present embodiment, the luminescence in which the respective wavelengths are mixed is resolved by the spectrometer 32 or the spectrum prism 32 to be guided to the light detector 33, and the signal processor 24 determines, on the basis of the detection signal S2 of the light detector 33, whether or not the contact hole 23 reaches the surface 20a of the first semiconductor layer film 21.

More specifically, in the present embodiment, the signal processor 24 intermittently drives the electron gun 12 in portions where the respective contact holes 23 are present, and the irradiation system irradiates the electron beam Er toward the contact hole 23, during a period represented by the period T2 illustrated by the part (a) of FIG. 5. Here, the materials structuring the first semiconductor layer film 20 and the second semiconductor layer film 21 are previously known and the attenuation time tr when the intermittent irradiation is carried out is also previously known. Therefore, for example, the signal processor 24 determines that the contact hole 23 does not meet the standard when the attenuation time tr is less than the predetermined value, whereas the signal processor 24 determines the contact hole 23 meets the standard when the attenuation time tr is more than the predetermined value.

Alternatively, in some cases, the signal processor 24 may be configured to determine that the contact hole 23 does not meet the standard when the attenuation time tr is more than the predetermined value, and determine that the contact hole 23 meet the standard when the attenuation time tr is less than the predetermined value.

In addition, it is possible to judge whether or not the contact hole 23 satisfies the standard, on the basis of the wavelengths of the luminescence.

Referring to FIG. 3D, in a case of the fluorescent image obtained by the contact hole 23 illustrated by Q3, the residual 34 is present in the contact hole 23. Since a part of an image LG3 in which the residue 34 is present becomes dark as illustrated in FIG. 3D when the residue 34 is a resist material, it is possible to determine that the residue 34 is present in the contact hole 23.

Also, when the residue 34 include a fluorescent material different from the fluorescent material structuring the first semiconductor layer film 20 and the second semiconductor layer film 21, luminescence having a wavelength different from those of the luminescence obtained by the first semiconductor layer film 20 and the second semiconductor layer film 21 is obtained. Hence, it is possible to determine that the residue 34 including the fluorescent material is present in the contact hole 23.

In a case of the contact hole 23 illustrated by Q4, as illustrated in FIG. 3E, the bottom part 23b of the contact hole 23 is present in the inner part or the back part of the first semiconductor layer film 20. Accordingly, the fluorescent image LG2 according to the luminescence from the first semiconductor layer film 20 present in the bottom part 23b of the contact hole 23, the fluorescent image LG3 according to the luminescence from the first semiconductor layer film 20 structuring a wall of the inner part or the back part of the contact hole 23, and the fluorescent image LG1 according to the luminescence from the second semiconductor layer film 21 structuring the wall of the contact hole 23, are obtained. Therefore, by comparing intensity of the fluorescent image LG3 with intensity of the fluorescent image LG1, it is possible to determine whether or not the contact hole 23 is formed in accordance with the standard.

In the present embodiment, the signal processor 24 has a function of controlling the electron lens 14 to change a focusing position of the electron beam Er.

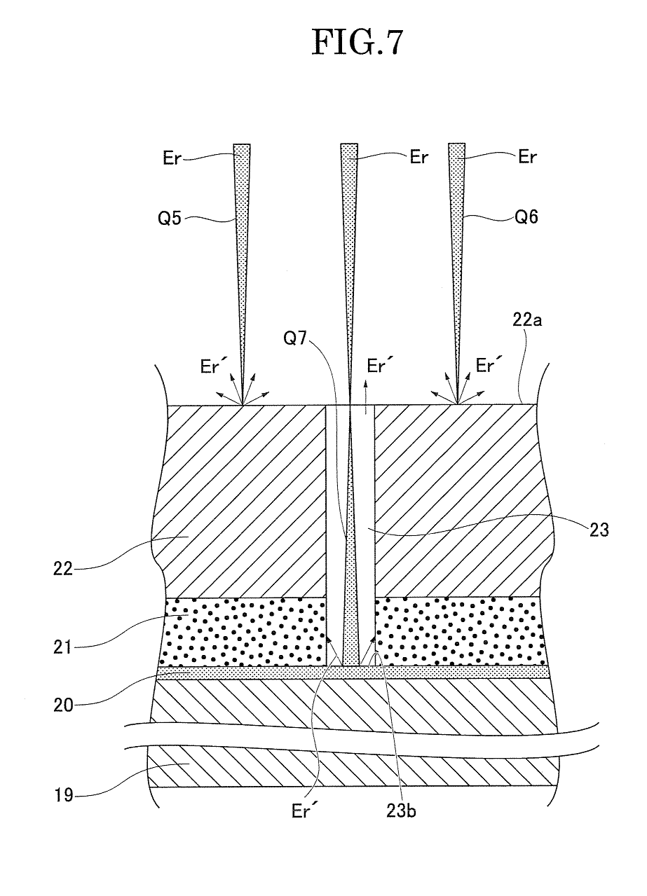

FIG. 7 schematically illustrates a state in which the electron beam Er is in focus on the surface of the wafer 18. As indicated by reference signs Q5 and Q6, when the electron beam Er is irradiated to the contact hole 23 in a case in which the electron beam Er is focused on the surface 22a of the resist film 22, the electron beam Er is widened in the bottom part 23b of the contact hole 23 as indicated by a reference sign Q7. Thus, an amount of the secondary electron Er′ excited by the electron beam Er is small, and the amount of the reflection secondary electron Er′ released outside from the contact hole 23 is small as well. Therefore, as already described above with reference to FIG. 4, the image 27 of the contact hole 23 is displayed darker than its surroundings.

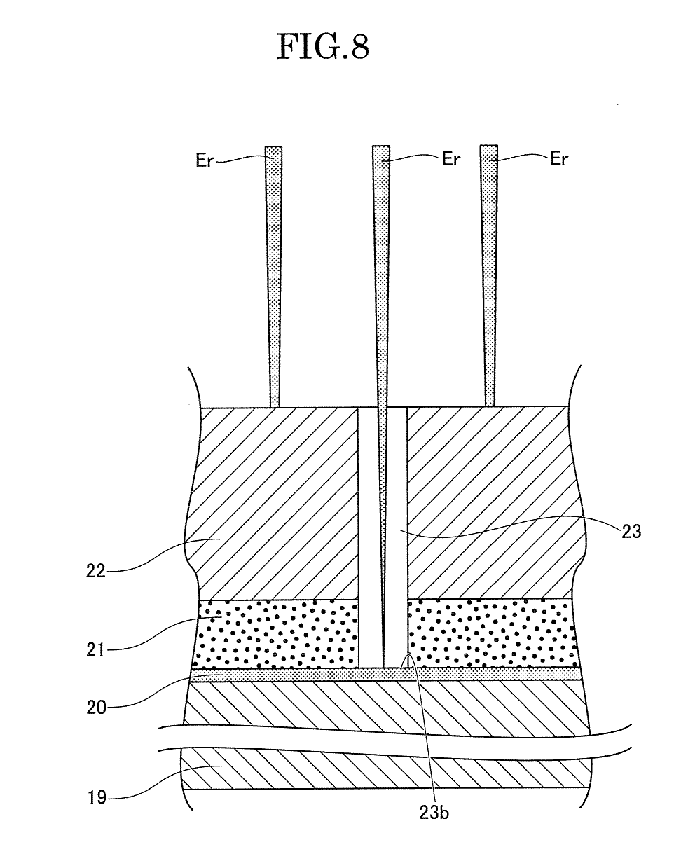

The signal processor 24, after having identified the position of the contact hole 23, changes the modes from the charged particle detection mode (or the secondary electron detection mode) to the luminescence detection mode. The signal processor 24, on the basis of the output of the detection signal S2 from the light detector 33, controls the electron lens 14 in a direction in which the detection signal S2 is increased. Thereby, the electron beam Er is focused on the bottom part 23b of the contact hole 23, as illustrated in FIG. 8.

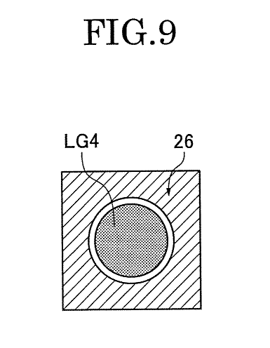

FIG. 9 schematically illustrates a fluorescent image LG4 obtained by the electron beam Er focused on the bottom part 23b of the contact hole 23. Referring to FIG. 9, therefore, the vivid fluorescent image LG4 of the contact hole 23 is obtained on the screen of the display 26.

More specifically, for example, the signal processor 24 determines that the irradiation of the electron beam Er onto the surface of the wafer 18 is performed when an output level of the detection signal S1 from the charged particle detector 25 is equal to or more than a predetermined value, and determines that the irradiation of the electron beam Er to the contact hole 23 is performed when the output level of the detection signal S1 is less than the predetermined value. In accordance with the determination, the signal processor 24 controls the electron lens 14 to adjust the focusing position of the electron beam Er. Therefore, the image preferable for the analysis of the sample having the large thickness and in which the shape of the concave portion is vivid is obtained.

Accordingly, it is possible to achieve the following (1) to (13) from the above-described exemplary embodiments of the present invention.

(1) A sample analyzing apparatus, comprising:

an irradiation system which intermittently irradiates a charged particle onto a sample having a concave portion partially on a surface thereof;

a light condensing reflecting mirror which condenses luminescence obtained from a side of the surface based on the irradiation of the charged particle;

a light detector which detects the luminescence guided to the light condensing reflecting mirror and which outputs a detection signal based on the detected luminescence;

a charged particle detector which detects the charged particle reflected from the surface of the sample as a reflection charged particle and which outputs a detection signal based on the detected reflection charged particle; and

a signal processor which controls the irradiation system to irradiate the charged particle intermittently, which obtains a shape of the sample on the basis of the detection signal outputted from the charged particle detector, and which identifies a material of the sample on the basis of an attenuation characteristic of the detection signal outputted from the light detector in a period from a time point in which the intermittent irradiation of the charged particle by the irradiation system is ended to a time point in which the intermittent irradiation of the charged particle by the irradiation system is started.

Therefore, according to (1), it is possible to provide the sample analyzing apparatus which is preferable for analyzing the sample having the large thickness, and which is also possible to perform the identification of the material of the sample.

### (2) A sample analyzing apparatus according to (1), wherein the sample includes a semiconductor having a resist on the surface, and the concave portion includes a contact hole.

Therefore, according to (2), it is possible to perform the inspection of the semiconductor, and in particular, it is preferable for performing the inspection as to whether or not the contact hole is formed in accordance with the standard.

(3) A sample analyzing apparatus according to (1), further comprising a memory which stores therein a previously set predetermined value, wherein the signal processor identifies the material of the sample on the basis of an attenuation time, as the attenuation characteristic, that a value of the detection signal, obtained from the light detector in the time point in which the intermittent irradiation of the charged particle by the irradiation system is ended, is reduced to the predetermined value.
(4) A sample analyzing apparatus according to (2), further comprising a memory which stores therein a previously set predetermined value, wherein the attenuation characteristic includes an attenuation time that a value of the detection signal, obtained from the light detector in the time point in which the intermittent irradiation of the charged particle by the irradiation system is ended, is reduced to the predetermined value, and wherein the signal processor determines that the contact hole does not meet a standard when the attenuation time is less than the predetermined value, and determines that the contact hole meets the standard when the attenuation time is more than the predetermined value.
(5) A sample analyzing apparatus according to (2), further comprising a memory which stores therein a previously set predetermined value, wherein the attenuation characteristic includes an attenuation time that a value of the detection signal, obtained from the light detector in the time point in which the intermittent irradiation of the charged particle by the irradiation system is ended, is reduced to the predetermined value, and wherein the signal processor determines that the contact hole does not meet a standard when the attenuation time is more than the predetermined value, and determines that the contact hole meets the standard when the attenuation time is less than the predetermined value.
(6) A sample analyzing apparatus according to (3), further comprising a spectrometer which resolves the luminescence into each wavelength to be guided to the light detector, wherein the light detector outputs the detection signal in which the luminescence is resolved by the spectrometer into each of the wavelengths, and wherein the signal processor identifies the material of the sample on the basis of the attenuation time of the detection signal which is outputted from the light detector and in which the luminescence is resolved into each of the wavelengths.
(7) A sample analyzing apparatus according to (3), further comprising a spectrum prism which resolves the luminescence into each wavelength to be guided to the light detector, wherein the light detector outputs the detection signal in which the luminescence is resolved by the spectrum prism into each of the wavelengths, and wherein the signal processor identifies the material of the sample on the basis of the attenuation time of the detection signal which is outputted from the light detector and in which the luminescence is resolved into each of the wavelengths.
(8) A sample analyzing apparatus according to (3), wherein the signal processor controls the irradiation system to vary acceleration voltage of the charged particle, and identifies the material of the sample on the basis of the acceleration voltage, in addition to the attenuation time.
(9) A sample analyzing apparatus according to (6), wherein the signal processor measures peak values of the luminescence for each of the wavelengths, compares the attenuation time and the peak values obtained by the actual measurement with attenuation time and peaks values as known values for each material stored in the memory, and identifies the material of the sample on the basis of the comparison of the attenuation time and the peak values obtained by the actual measurement and the attenuation time and the peaks values of each material stored in the memory.
(10) A sample analyzing apparatus according to (7), wherein the signal processor measures peak values of the luminescence for each of the wavelengths, compares the attenuation time and the peak values obtained by the actual measurement with attenuation time and peaks values as known values for each material stored in the memory, and identifies the material of the sample on the basis of the comparison of the attenuation time and the peak values obtained by the actual measurement and the attenuation time and the peaks values of each material stored in the memory.

Therefore, according to (3) to (10), it is possible to perform the identification of the material structuring the semiconductor, accurately.

(11) A sample analyzing apparatus according to (1), wherein the irradiation system includes an optical element which varies a focusing position of the charged particle when the charged particle is irradiated onto the sample, and wherein the signal processor drives the optical element to adjust the focusing position of the charged particle on the basis of the detection signal outputted from the light detector.
(12) A sample analyzing apparatus according to (11), further comprising a memory which stores therein a previously set predetermined value, wherein the signal processor determines that the irradiation of the charged particle onto the surface of the sample is performed when an output level of the detection signal from the charged particle detector is equal to or more than the predetermined value, and determines that the irradiation of the charged particle to the concave portion is performed when the output level of the detection signal from the charged particle detector is less than the predetermined value.

Therefore, according to (11) and (12), it is possible to obtain the image preferable for the analysis of the sample having the large thickness and in which the shape of the concave portion is vivid.

(13) A sample analyzing apparatus according to (1), wherein the signal processor includes a constant driving mode for controlling the irradiation system to irradiate the charged particle onto the surface of the sample constantly, and an intermittent driving mode for controlling the irradiation system to irradiate the charged particle on the surface of the sample intermittently.

Therefore, according to (13), it is possible to provide the sample analyzing apparatus which is further preferable for analyzing the sample having the large thickness, and which is also possible to perform the identification of the material of the sample.

Although the present invention has been described in terms of exemplary embodiments, it is not limited thereto. It should be appreciated that variations may be made in the embodiments described by persons skilled in the art without departing from the scope of the present invention as defined by the following claims. The limitations in the claims are to be interpreted broadly based on the language employed in the claims and not limited to examples described in the present specification or during the prosecution of the application, and the examples are to be construed as non-exclusive. For example, in the present disclosure, the term “preferably”, “preferred” or the like is non-exclusive and means “preferably”, but not limited to. Moreover, no element or component in the present disclosure is intended to be dedicated to the public regardless of whether the element or component is explicitly recited in the following claims.

What is claimed is:

1. A sample analyzing apparatus, comprising:
an irradiation system which intermittently irradiates a charged particle onto a sample having a concave portion partially on a surface thereof;
a light condensing reflecting mirror which condenses luminescence obtained from a side of the surface based on the irradiation of the charged particle;
a light detector which detects the luminescence guided to the light condensing reflecting mirror and which outputs a detection signal based on the detected luminescence;
a charged particle detector which detects the charged particle reflected from the surface of the sample as a reflection charged particle and which outputs a detection signal based on the detected reflection charged particle; and
a signal processor which controls the irradiation system to irradiate the charged particle intermittently, which obtains a shape of the sample on the basis of the detection signal outputted from the charged particle detector, and which identifies a material of the sample on the basis of an attenuation characteristic of the detection signal outputted from the light detector in a period from a time point in which the intermittent irradiation of the charged particle by the irradiation system is ended to a time point in which the intermittent irradiation of the charged particle by the irradiation system is started.

2. A sample analyzing apparatus according to claim 1, wherein the sample includes a semiconductor having a resist on the surface, and the concave portion includes a contact hole.

3. A sample analyzing apparatus according to claim 1, further comprising a memory which stores therein a previously set predetermined value, wherein the signal processor identifies the material of the sample on the basis of an attenuation time, as the attenuation characteristic, that a value of the detection signal, obtained from the light detector in the time point in which the intermittent irradiation of the charged particle by the irradiation system is ended, is reduced to the predetermined value.

4. A sample analyzing apparatus according to claim 2, further comprising a memory which stores therein a previously set predetermined value, wherein the attenuation characteristic includes an attenuation time that a value of the detection signal, obtained from the light detector in the time point in which the intermittent irradiation of the charged particle by the irradiation system is ended, is reduced to the predetermined value, and wherein the signal processor determines that the contact hole does not meet a standard when the attenuation time is less than the predetermined value, and determines that the contact hole meets the standard when the attenuation time is more than the predetermined value.

5. A sample analyzing apparatus according to claim 2, further comprising a memory which stores therein a previously set predetermined value, wherein the attenuation characteristic includes an attenuation time that a value of the detection signal, obtained from the light detector in the time point in which the intermittent irradiation of the charged particle by the irradiation system is ended, is reduced to the predetermined value, and wherein the signal processor determines that the contact hole does not meet a standard when the attenuation time is more than the predetermined value, and determines that the contact hole meets the standard when the attenuation time is less than the predetermined value.

6. A sample analyzing apparatus according to claim 3, further comprising a spectrometer which resolves the luminescence into each wavelength to be guided to the light detector, wherein the light detector outputs the detection signal in which the luminescence is resolved by the spectrometer into each of the wavelengths, and wherein the signal processor identifies the material of the sample on the basis of the attenuation time of the detection signal which is outputted from the light detector and in which the luminescence is resolved into each of the wavelengths.

7. A sample analyzing apparatus according to claim 3, further comprising a spectrum prism which resolves the luminescence into each wavelength to be guided to the light detector, wherein the light detector outputs the detection signal in which the luminescence is resolved by the spectrum prism into each of the wavelengths, and wherein the signal processor identifies the material of the sample on the basis of the attenuation time of the detection signal which is outputted from the light detector and in which the luminescence is resolved into each of the wavelengths.

8. A sample analyzing apparatus according to claim 3, wherein the signal processor controls the irradiation system to vary acceleration voltage of the charged particle, and identifies the material of the sample on the basis of the acceleration voltage, in addition to the attenuation time.

9. A sample analyzing apparatus according to claim 6, wherein the signal processor measures peak values of the luminescence for each of the wavelengths, compares the attenuation time and the peak values obtained by the actual measurement with attenuation time and peaks values as known values for each material stored in the memory, and identifies the material of the sample on the basis of the comparison of the attenuation time and the peak values obtained by the actual measurement and the attenuation time and the peaks values of each material stored in the memory.

10. A sample analyzing apparatus according to claim 7, wherein the signal processor measures peak values of the luminescence for each of the wavelengths, compares the attenuation time and the peak values obtained by the actual measurement with attenuation time and peaks values as known values for each material stored in the memory, and identifies the material of the sample on the basis of the comparison of the attenuation time and the peak values obtained by the actual measurement and the attenuation time and the peaks values of each material stored in the memory.

11. A sample analyzing apparatus according to claim 1, wherein the irradiation system includes an optical element which varies a focusing position of the charged particle when the charged particle is irradiated onto the sample, and wherein the signal processor drives the optical element to adjust the focusing position of the charged particle on the basis of the detection signal outputted from the light detector.

12. A sample analyzing apparatus according to claim 11, further comprising a memory which stores therein a previously set predetermined value, wherein the signal processor determines that the irradiation of the charged particle onto the surface of the sample is performed when an output level of the detection signal from the charged particle detector is equal to or more than the predetermined value, and determines that the irradiation of the charged particle to the concave portion is performed when the output level of the detection signal from the charged particle detector is less than the predetermined value.

13. A sample analyzing apparatus according to claim 1, wherein the signal processor includes a constant driving mode for controlling the irradiation system to irradiate the charged particle onto the surface of the sample constantly, and an intermittent driving mode for controlling the irradiation system to irradiate the charged particle on the surface of the sample intermittently.
